(19) United States
(12) Patent Application Publication
(10) Pub. No.: US 2020/0038997 A1
(43) Pub. Date: Feb. 6, 2020

(54) Method for Producing a Component Assembly, and Component Assembly

(71) Applicant: Bayerische Motoren Werke Aktiengesellschaft, Muenchen (DE)

(72) Inventor: Markus LACHENMAIER, Moorenweis (DE)

(21) Appl. No.: 16/600,921

(22) Filed: Oct. 14, 2019

Related U.S. Application Data
(63) Continuation of application No. PCT/EP2018/059926, filed on Apr. 18, 2018.

(30) Foreign Application Priority Data
Jun. 7, 2017 (DE) 10 2017 209 599.7

(51) Int. Cl. B23K 26/242; B23K 26/32; B23K 26/354; B23K 26/082

(52) U.S. Cl. CPC B23K 26/242; B23K 26/32; B23K 2103/10; B23K 26/082; B23K 26/354

(57) ABSTRACT

A method produces a component assembly, in which a first component and a second component are welded together, forming a front fillet weld. To reduce susceptibility to corrosion, a connection region to be smoothed, which includes the front fillet weld and component sections adjacent thereto on both sides, is melted, at least on the surface, such that the surface in the smoothed region extends continuously and the transition to adjacent unsmoothed regions is edge-free, and impurities are eliminated.

### CROSS REFERENCE TO RELATED APPLICATIONS

This application is a continuation of PCT International Application No. PCT/EP2018/059926, filed Apr. 18, 2018, which claims priority under 35 U.S.C. § 119 from German Patent Application No. 10 2017 209 599.7, filed Jun. 7, 2017, the entire disclosures of which are herein expressly incorporated by reference.

### BACKGROUND AND SUMMARY OF THE INVENTION

The invention relates to a method for producing a component assembly and a component assembly.

Welding is an established method for producing a component assembly. In this case, material of the components to be joined is melted by an introduction of energy. The melt mixes and cools to form a weld seam, which connects the components in an integrally joined manner. The welding can be carried out with and without additional material. Lap fillet welds are frequently used for welded bonds in vehicle construction. A lap fillet weld is understood as a welded bond between two components, wherein an upper component bears in an at least partially overlapping manner on a lower component and the weld seam is formed between at least one edge face or flank face of the upper component and the adjoining bearing surface of the lower component. Such a weld seam can also be referred to as a flank fillet weld. The lap fillet weld can be formed as a continuous weld seam or in the manner of a stepped seam (i.e., having seam interruptions).

In addition to the strength of the weld seam, it is of enormous importance in the vehicle industry that the joint has a low tendency toward corrosion.

It is routine to provide weld seams later with an anticorrosion seal, for example, a KTL coating. Depending on the quality of the welded bond, however, subsequent processing of the components, for example, additional cleaning, is required for this purpose.

Against this background, it is the object of the present invention to provide a method for reducing the tendency toward corrosion in a component assembly using simple means and performed reliably.

The object is achieved by a method and a component assembly according to the claimed invention.

A method is specified in which at least a first and a second component are welded to one another to form a lap fillet weld. According to the invention, after the formation of the lap fillet weld, at least superficial melting, smoothing, and cleaning (removal of contaminants, for example, smoke) of a connecting region of the components are performed. The connecting region comprises the lap fillet weld and also component portions of the first and second component laterally adjoining the lap fillet weld. The width of the component portions in which smoothing/cleaning is carried out can vary and is preferably selected so that edges and weld penetration marks are melted. The re-melting and smoothing are carried out in such a way that the connecting region is formed free of edges and shoulders. In particular, the surface of the smoothed connecting region has a continuous profile and merges continuously into the surface of the unsmoothed component portions, which adjoin the connecting region.

For the smoothing, the lap fillet weld and, viewed in the seam direction, the laterally adjoining component portions are superficially melted. The seam itself is smoothed, cleaned of contaminants, and a continuous and edge-free transition from the components into the weld seam is produced. In particular, the upper plate component is rounded in the edge region by the smoothing. The smoothing also takes place on the side of the lower plate component. In this case, in addition to a fluid transition between component and seam, a cleaning action is also achieved and, for example, smoke traces from the preceding weld seam production are removed.

It has been shown that such a smoothed component contour has a significantly reduced tendency toward corrosion and, in particular, the filiform corrosion can be suppressed and/or greatly reduced.

A particularly high surface quality of the smoothed region may be achieved if the melting or the smoothing is performed in one preferred embodiment by use of a laser beam, which is guided in an oscillating and defocused manner over the region to be smoothed. In this case, the introduction of energy is selected so that the desired degree of the melting and/or the depth of the melting is achieved. The focal position can be set above or below the joining plane. The shape of the oscillation is not restricted to a specific shape and can be, for example, sinusoidal or circular or can have arbitrary other shapes. It is apparent to a person skilled in the art that the melting and smoothing can also be performed with a focused laser beam upon suitable selection of the welding parameters and oscillation parameters.

It can be advantageous if a connecting region is smoothed which has a width which corresponds to at least twice the weld seam width. For example, component portions on the right and left of the lap fillet weld having a width of at least half the width of the lap fillet weld can be smoothed for this purpose.

It has proven to be particularly advantageous for the prevention of the filiform corrosion if the smoothed component and seam surfaces have a mean roughness value R_{A} of 3 μm (micrometers) or less.

Because of the high achievable processing speeds, it is particularly advantageous if the smoothing is performed by a scanner-based remote laser beam device. In remote laser beam welding, a high-energy laser beam having large focal length, for example, more than 30 cm, is directed onto the components. Scanner-based remote laser beam devices additionally have a scanner optical unit for the beam deflection, which enable a highly dynamic positioning of the laser beam by way of adjustable mirrors. If such scanner-based remote laser systems are operated “on-the-fly”, i.e., the scanner optical unit is additionally positionable by a robot, working speeds of up to 9 m/minute and above may thus be achieved.

The method is particularly suitable for bonding materials to one another which typically form a weld seam having poor surface quality. In one preferred embodiment, aluminum components are connected using the method, wherein this is also to be understood to include components made of aluminum alloys.

Furthermore, a component assembly is specified comprising a first component and a second component, which are welded to one another using a lap fillet weld. In a connecting region, which comprises both the lap fillet weld and also portions of the first and second component adjoining laterally thereon (viewed in the longitudinal direction of the lap fillet weld), the surface of the component assembly is smoothed by melting, so that the surface in the connecting region has a continuous profile and merges without edges into the unsmoothed regions.

The component assembly is preferably produced using the above-described method and as such achieves the same technical effects and advantages described with respect to the method.

The components are preferably plate components, wherein they can be both flat plate portions and also three-dimensionally formed plates (plate formed parts). Preferably fine plates having a thickness of less than 3 mm are used as the plates. In principle, all weldable materials or material combinations are contemplated as materials for the plates, for example, steel plates (with and without corrosion coating) or plates made of aluminum or magnesium alloys. However, the method achieves special advantages if the plate components are formed from an aluminum alloy and in particular from 5000 or 6000 series aluminum alloys, which tend toward scaly seam surfaces and are therefore generally problematic to process.

The component assembly produced using the method has a significantly reduced tendency toward corrosion. The method is thus suitable in particular for producing component assemblies which require a high corrosion resistance. In one preferred embodiment, a component assembly is produced using the method which is a vehicle body component or vehicle body add-on component, for example, a vehicle door or a vehicle hatch.

The above-described properties, features, and advantages of this invention and the manner in which they are achieved will become clearer and more comprehensible on the basis of the drawing and in conjunction with the following description of the exemplary embodiments. If the term “can” is used in this application, it refers to both the technical possibility and also the actual technical implementation.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic illustration of a component assembly having a formed lap fillet weld, which is already partially smoothed.

FIG. 2 is a sectional view of the unsmoothed lap fillet weld from FIG. 1.

FIG. 3 is a sectional view of the component assembly from FIG. 1 having an already smoothed connecting region.

### DETAILED DESCRIPTION OF THE DRAWINGS

The present invention will be explained on the basis of the component assembly 1 shown in FIG. 1.

A first component 2 is welded to a second component 3 by a lap fillet weld 4. The components 2 and 3 can be, for example, an inner plate and an outer plate of a vehicle door.

The lap fillet weld 4 extends along the end face of the first component 2 and can have, for example, a profile curved three-dimensionally or in the plane. Upper and lower plates 2, 3 can also be connected to one another by multiple lap fillet welds. The lap fillet welds can be formed using conventional methods, with and without additional material. The formation of the lap fillet weld by tactile laser welding has proven itself in particular, the position of the laser beam being guided by a tactile seam guiding system, which feels along the fillet like a feeler.

After the formation of the lap fillet weld 4, a laser beam L of a laser remote device is now oriented onto the connecting region 5 to be smoothed (indicated by the dashed lines in FIG. 1) and guided along it. The connecting region 5 comprises the weld seam 4, and also a component portion 6 of the first component 2 adjoining the weld seam and a component portion 7 of the second component 3.

The laser beam L is guided over the connecting region, wherein it effectuates superficial melting of the material of the weld seam 4, and of the adjoining component portions 6, 7. The laser beam L is used as a defocused beam, i.e., it has a focal position which is located significantly above or below the weld seam plane, whereby the energy density coupled into the components is reduced. The resulting relatively large laser spot is additionally moved in an oscillating manner over the components, illustrated by the arrow O in FIG. 1. The oscillation O superimposed on the advancing movement V of the laser beam L can have any arbitrary shape in this case, for example, a circular or sinusoidal oscillation or other shapes. The melting can take place very rapidly due to the use of a scanner-based laser remote facility, for example, at working speeds of up to 9 m/minute.

The superficial melting effectuated by the laser beam L results in smoothing of the seam region and harmonization of the topography of the components 2, 3 in the connecting region 5. As a result, the connecting region located in the advancing direction behind the laser beam L is provided as a smoothed region 5A. In particular, the width of the connecting region 5 is selected in such a way that an edge of the upper plate is completely melted and a rounded transition free of edges and shoulders is formed between the weld seam 4 and the first component or upper plate 2. The connecting region 5 has a width, for example, which corresponds to at least twice the weld seam width, thus, for example, a strip having at least half of the width of the weld seam 4 is smoothed on the right and left of the weld seam. The molten material partially also flows in the direction toward the second component 3 or lower plate, where it effectuates a smoothing of the transition between lap fillet weld 4 and lower plate 3. In addition, cleaning of the surface from smoke traces and other contaminants is achieved by the laser beam smoothing.

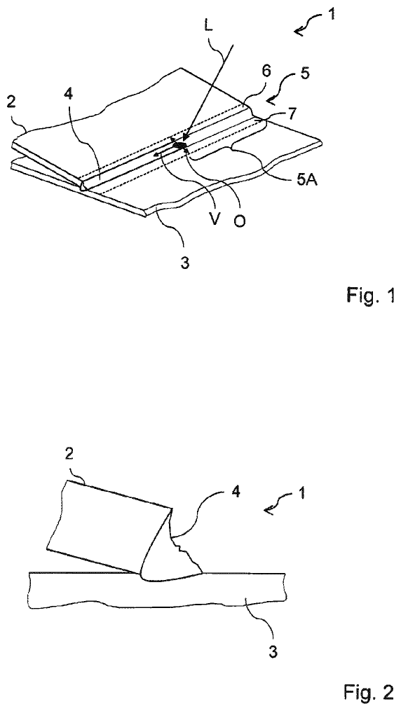

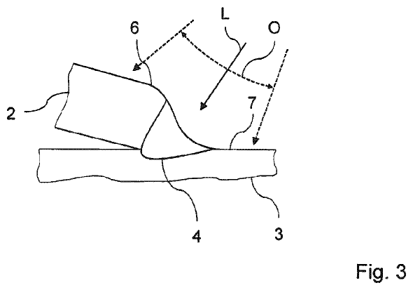

The component assembly 1 thus produced is distinguished by a lap fillet weld 4 having a very smooth surface and a continuous surface profile, i.e., free of edges and shoulders, in the region of the connection section 5. The tendency toward corrosion is significantly reduced, moreover the durability of corrosion protection layers, which are applied in subsequent processing steps, improves on the smoothed surface. FIGS. 2 and 3 additionally show a sectional view of the lap fillet weld before the smoothing (FIG. 2) and after the smoothing (FIG. 3). Moreover, the oscillation of the laser beam L having the maximum deflections is shown in FIG. 3.

The exemplary embodiments are not to scale and are not restrictive. Modifications in the scope of routine measures in the art are possible.

### LIST OF REFERENCE SIGNS

1 component assembly
2, 3 components
4 lap fillet weld
5 connecting region
5A smoothed connecting region
6, 7 component portion
O oscillation movement
L laser beam
V advancing direction

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for producing a component assembly having reduced tendency toward corrosion, the method comprising:
welding a first component and a second component to one another to form a lap fillet weld;
at least superficially melting a connecting region to be smoothed, which connecting region comprises the lap fillet weld and component portions adjoining thereon on both sides, such that a surface has a continuous profile in a smoothed connecting region and merges without edges into adjoining unsmoothed regions.

2. The method according to claim 1, wherein
the smoothing is performed by a laser beam, which is guided in an oscillating and defocused manner over the connecting region to be smoothed.

3. The method according to claim 2, wherein
the smoothed connecting region has a width which corresponds to at least twice the weld seam width.

4. The method according to claim 1, wherein
the smoothed connecting region has a width which corresponds to at least twice the weld seam width.

5. The method according to claim 3, wherein
the smoothed connecting region has a mean roughness value of 3 μm or less.

6. The method according to claim 1, wherein
the smoothed connecting region has a mean roughness value of 3 μm or less.

7. The method according to claim 1, wherein
the smoothing is performed by a scanner-based remote laser beam device.

8. The method according to claim 1, wherein
the first and second components are aluminum components.

9. A component assembly, comprising:
a first component and a second component, which are welded to one another by a lap fillet weld to form the component assembly, wherein
a surface of the component assembly is smoothed by melting in a connecting region, which comprises both the lap fillet weld and also portions adjoining laterally thereon of the first and second components, in such a way that the surface has a continuous profile in the connecting region and merges without edges into adjoining unsmoothed regions.

10. The component assembly according to claim 9, wherein
the surface has a mean roughness value of less than 3 μm in the smoothed connecting region.

11. The component assembly according to claim 10, wherein
the first and second components are vehicle body components or vehicle body add-on components.

12. The component assembly according to claim 9, wherein
the component assembly is a vehicle door or a vehicle hatch.
